(19) United States
(12) Patent Application Publication
(10) Pub. No.: US 2007/0295144 A1
(43) Pub. Date: Dec. 27, 2007

(54) Steering device

(75) Inventors: Masaki Nishioka, Nabari-Shi (JP); Masaya Jouta, Midori-Shi (JP)

Correspondence Address: SIDLEY AUSTIN LLP, 717 NORTH HARWOOD, SUITE 3400, DALLAS, TX, 75201, US

(73) Assignee: NSK LTD.

(21) Appl. No.: 11/805,793

(22) Filed: May 24, 2007

(30) Foreign Application Priority Data
May 26, 2006 (JP) 2006-147187

(51) Int. Cl. B62D 1/18; B62D 1/16

(52) U.S. Cl. 74/493; 280/775

(57) ABSTRACT

A steering device which, having a movable wedge smoothly movable to clamp a column, is capable of a secure clamping operation is provided. A center axis of a column clamp shaft is disposed to pass through a middle position of a length of contact between a slope of a first wedge and a slope of a third wedge and a middle position of a length of contact between a slope of a second wedge and another slope of the third wedge. Pressing forces to which the first and second wedges are subjected when a column is clamped act on the middle positions of the lengths of contact, so that no rotational moment is applied to the first and second wedges. The first and second wedges can therefore move smoothly over the slopes of the third wedge, respectively.

### FIELD OF THE INVENTION

The present invention relates to a steering device, particularly, to a steering device for a vehicle, the steering device having a telescopic mechanism.

### BACKGROUND OF THE INVENTION

The telescopic mechanism is for adjusting the position in the vehicle front-rear direction of the steering wheel of a vehicle according to the physique and preferences of the driver to enable the driver to operate the steering wheel most comfortably.

The telescopic mechanism has a column clamp which is clamped and unclamped when adjusting the position in the front-rear direction of the steering wheel. Namely, when telescopically adjusting the position in the front-rear direction of the steering wheel, the column clamp is once unclamped. After the position in the front-rear direction of the steering wheel is adjusted, the column clamp is clamped again.

A steering device which enables stable clamping and unclamping operations is proposed in Japanese Unexamined Patent Application Publication No. 2005-88755. The steering device is equipped with a control lever which can be operated with ease to carry out clamping and unclamping operations and a column clamp the clamping force of which can be adjusted with ease.

In the steering device proposed in Japanese Unexamined Patent Application Publication No. 2005-88755, a movable wedge having a slope which engages a slope of a fixed wedge is moved, by a column clamp shaft, over a slope of a movable column member to cause the movable column member to be clamped to a fixed column member.

In the steering device proposed in Japanese Unexamined Patent Application Publication No. 2005-88755, the area of contact between the slope of the fixed wedge and the slope of the movable wedge is spaced apart from a center of the column clamp shaft. When the movable wedge is pressed by the column clamp shaft, therefore, a rotational moment about the area of contact between the slope of the fixed wedge and the slope of the movable wedge acts on the movable wedge causing the movable wedge to be inclined and made unable to move smoothly. This makes it possible that the movable wedge stops moving during a clamping or unclamping operation or that the clamping force generated to clamp the movable column member is reduced.

### SUMMARY OF THE INVENTION

An object of the present invention is to provide a steering device which, having a movable wedge smoothly movable to clamp a column, is capable of a secure clamping operation.

The above object is achieved as follows. The first invention provides a steering device which comprises: a fixed column member having a body attaching part for attaching the steering device to a vehicle body; a movable column member, one end of the movable column member being supported by the fixed column member nonrotatably about and movably along a center axis of the fixed column member; a steering shaft which is rotatably supported by the movable column member and to one end of which a steering wheel is fixed; a movable wedge movably supported by one of the movable column member and the fixed column member, the movable wedge having a clamp face and a slope formed on a side opposite to the clamp face; a fixed wedge fixed to the one of the movable column member and the fixed column member, the fixed wedge having a slope which engages the slope of the movable wedge; and a column clamp shaft operable by a vehicle driver to move the movable wedge over the slope of the fixed wedge. In the steering device, a center axis of the column clamp shaft substantially passes through a middle point of a contact area of the slopes of the movable wedge and the fixed wedge.

The second invention provides a steering device according to the first invention, wherein a normal line passing through a center of the clamp face of the movable wedge substantially passes through the middle point of the contact area.

The third invention provides a steering device according to one of the first and second inventions, the steering device further comprising another movable wedge and another fixed wedge, the another movable wedge and the another fixed wedge being spaced apart, in a direction of a center axis of the fixed column member, from the movable wedge and the fixed wedge, respectively. In the steering device, the two movable wedges move closer to or away from the fixed column member to clamp the movable column member to the fixed column member by moving closer to or away from each other.

The fourth invention provides a steering device according to the third invention, wherein a spring is provided between the two movable wedges for biasing the movable wedges away from each other.

In the steering device according to the present invention, a column clamp shaft for moving a movable wedge is disposed such that it presses the movable wedge at an approximately middle position of the length of contact between mutually engaging slopes of the movable wedge and a fixed wedge. Since this reduces the rotational moment acting on the movable wedge, the movable wedge can be moved smoothly enabling a secure clamping operation.

### BRIEF DESCRIPTION OF THE DRAWINGS

FIG. 1 is an external view of a steering device 1 according to a first embodiment of the present invention.

FIG. 2 is a top view showing the steering device 1 as seen in the direction of arrow P in FIG. 1.

FIG. 3 is a bottom view of the steering device 1 as seen in the direction of arrow Q in FIG. 1.

FIG. 4 is an enlarged side view showing an essential part of the steering device 1 shown in FIG. 1.

FIG. 5 is an enlarged partly-cross-sectional bottom view corresponding to FIG. 3.

FIG. 6 is a cross-sectional view taken along line A-A in FIG. 1.

FIG. 7 is a cross-sectional view taken along line B-B in FIG. 1.

FIG. 8 is a side view showing an essential part of a column clamp.

FIG. 9 is a cross-sectional view taken along line C-C in FIG. 5 in which the column clamp is shown.

FIG. 10 is an exploded view of the column clamp in a sub-assembled state.

FIG. 11 is a cross-sectional view taken along line D-D in FIG. 1.

FIG. 12 is a cross-sectional view taken along line E—E in FIG. 4.

FIG. 13 is an exploded perspective view showing a swing lever and a swing lever retention spring.

FIG. 14 (1) is an operation diagram showing a bias direction reversing mechanism 81 and a swing lever retention mechanism 85 with a control lever 7 in an end position a for clamping.

FIG. 14 (2) is an operation diagram showing the bias direction reversing mechanism 81 and the swing lever retention mechanism 85 with the control lever 7 in an end position b for unclamping.

FIG. 15 is an enlarged view of a contact area where a slope 644 of a second wedge 64 and a slope 653 of a third wedge 65 shown in FIG. 8 are in contact with each other.

FIG. 16 is an enlarged view of a contact area where a slope 644 of a second wedge 64 and a slope 653 of a third wedge 65 according to a second embodiment are in contact with each other.

FIGS. 17 (a) to 17 (f) are conceptual diagrams each showing an example of a wedge arrangement.

### DETAILED DESCRIPTION OF THE PREFERRED EMBODIMENTS

In the following, embodiments of the present invention will be described with reference to the accompanying drawings.

### First Embodiment

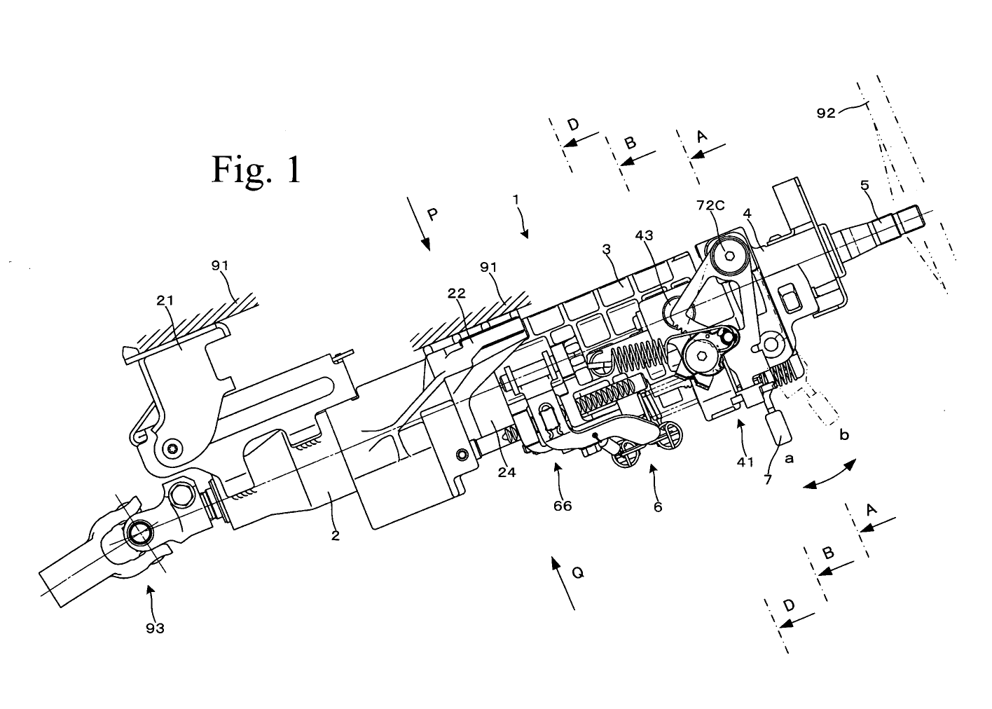

FIGS. 1 to 14 show a steering device according to a first embodiment of the present invention. In the steering device according to the first embodiment, a telescopic mechanism and a tilting mechanism can be clamped or unclamped simultaneously by operating a single control lever in one direction. Furthermore, when the control lever is released, both the telescopic mechanism and the tilting mechanism are held in an unclamped state.

### General Outline

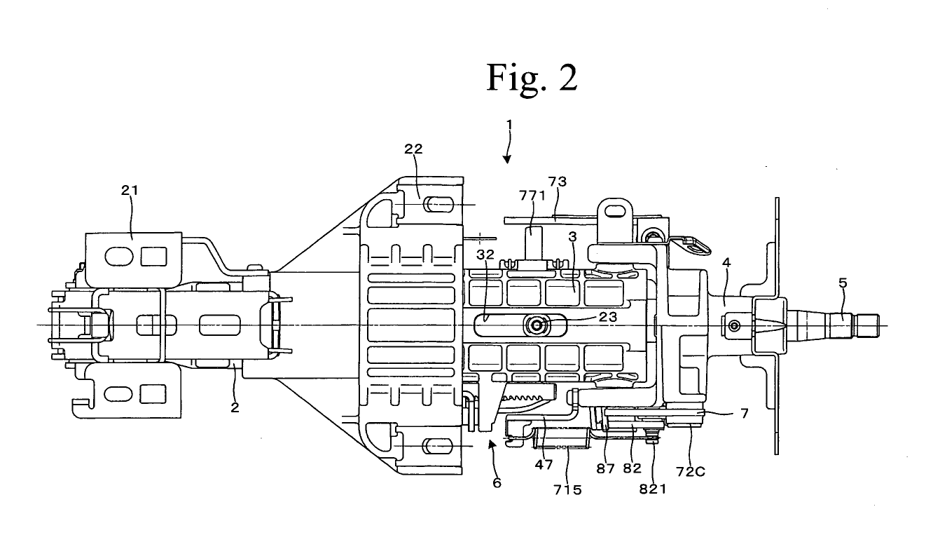

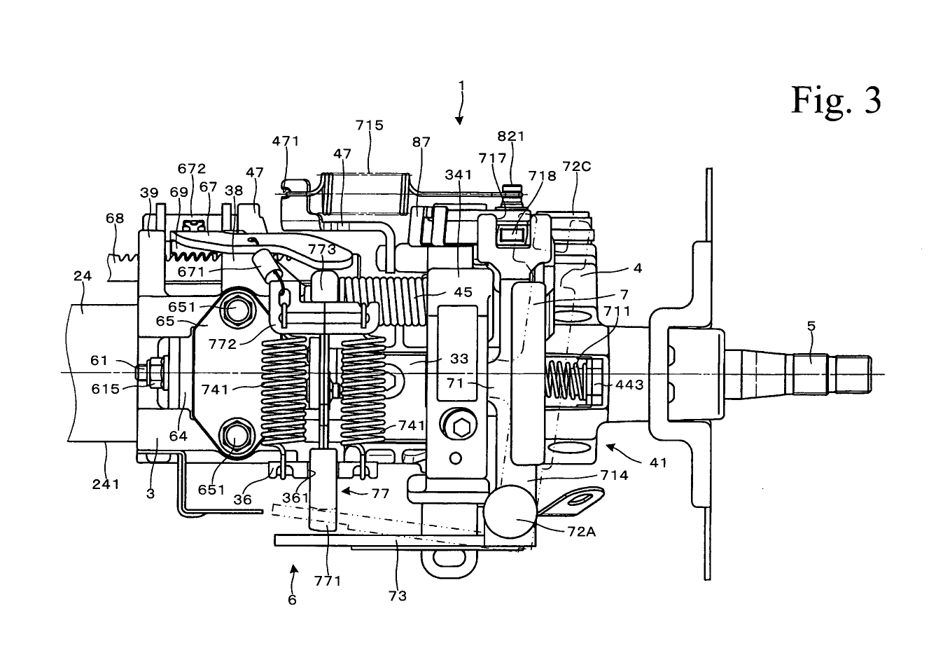

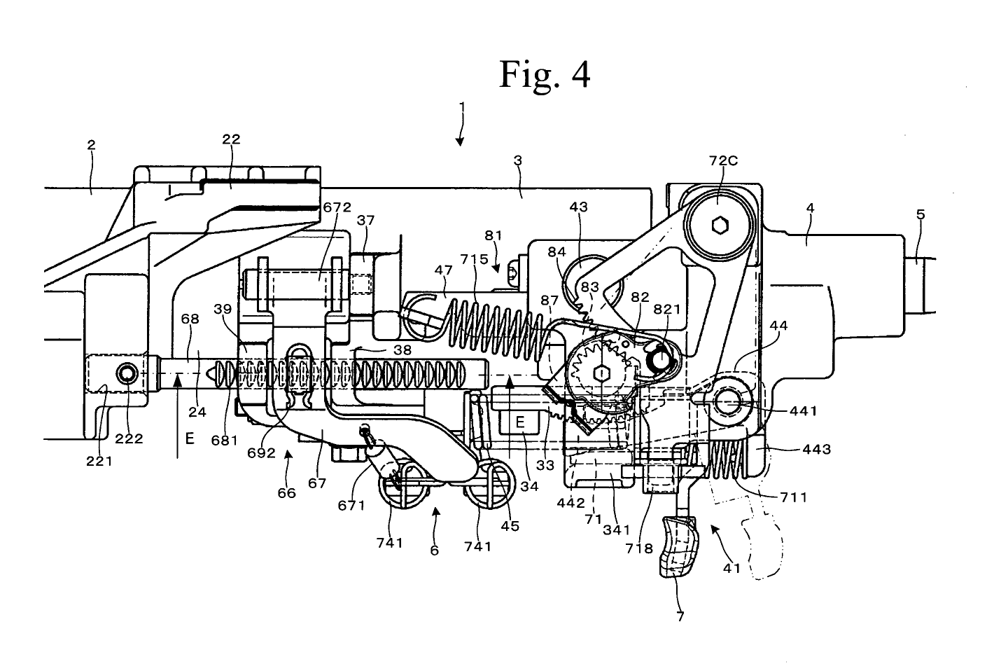

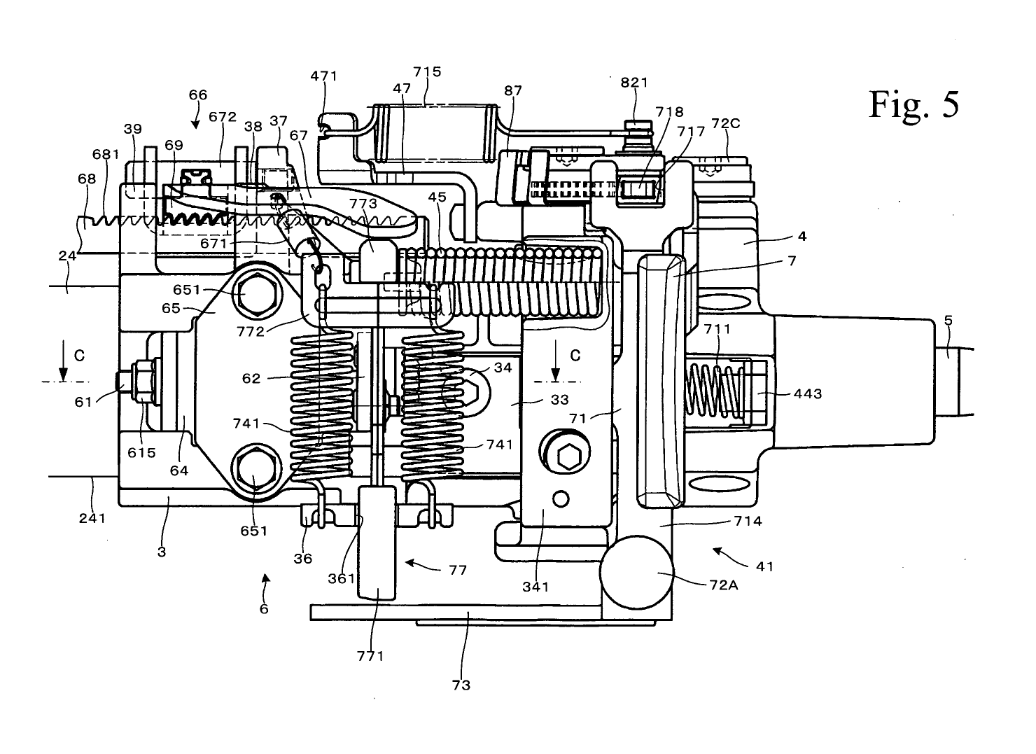

FIG. 1 is an external view of a steering device 1 according to the first embodiment of the present invention. FIG. 2 is a top view showing the steering device 1 as seen in the direction of arrow P in FIG. 1. FIG. 3 is a bottom view of the steering device 1 as seen in the direction of arrow Q in FIG. 1. FIG. 4 is an enlarged side view showing an essential part of the steering device 1. FIG. 5 is an enlarged partly-cross-sectional bottom view corresponding to FIG. 3.

The steering column 1 includes a fixed column member 2, a movable column member 3, a tilt head 4, a steering shaft 5, a column clamp 6, a tilt head clamp 41, and a control lever 7.

The fixed column member 2 is equipped with a front body attaching part 21 and a rear body attaching part 22 which are used to attach the fixed column member 2 to a vehicle body 91. The movable column member 3 is supported on the fixed column member 2 to be nonrotatable about and movable in parallel with the center axis of the fixed column member 2. The tilt head 4 is supported on the right end side, as seen in FIG. 1, of the movable column member 3 to be tiltable about a tilt center shaft 43. The steering shaft 5 is rotatably supported by the tilt head 4. A steering wheel 92 is fixed to a right end portion of the steering shaft 5.

The movable column member 3 is equipped with the column clamp 6. The column clamp 6 is provided with a column clamp shaft 61 extending in parallel with the center axes of the fixed column member 2 and movable column member 3. The column clamp 6 is fixed to the movable column member 3 and is movable relative to the fixed column member 2. The movable column member 3 can be clamped to and unclamped from the fixed column member 2 by operating the column clamp 6.

The movable column member 3 is provided with the tilt head clamp 41 that clamps and unclamps the tilt head 4 to and from the movable column member 3. The control lever 7 is supported by the tilt head 4. The control lever 7 is disposed in a position apart from the steering wheel 92. This prevents the driver driving the vehicle from unintentionally touching the control lever while operating the steering wheel 92 and causing the movable column member 3 or the tilt head 4 to be unclamped. The position of the control lever 7 is also intended not to disturb operation of switches disposed around the steering wheel 92.

When the control lever 7 is moved toward the steering wheel 92, a driven lever 714 (FIGS. 3 and 5) is driven to operate the column clamp 6 causing the movable column member 3 to be unclamped. Moving the control lever 7 toward the steering wheel 92 also causes the tilt head 4 to be unclamped.

The left end, as seen in FIG. 1, of the steering shaft 5 is connected to an upper universal joint (not shown) in the steering device 1. The center of the upper universal joint rests on the axis of the tilt center shaft 43, so that the upper universal joint is not affected by tilting of the tilt head 4.

The upper universal joint and a lower universal joint 93 are linked by a spline shaft which includes a male spline shaft and a female spline shaft (neither shown). The movable column member 3 is, therefore, movable in the left-right direction as seen in FIGS. 1 and 2. Thanks to the spline shaft providing spline couplings, when the steering wheel 92 is rotated, the rotation is transmitted, via the lower universal joint 93, to a steering gear to control the front wheel direction regardless of the position of the movable column member 3 and the position in the front-rear direction of the steering wheel 92.

### Tilt Head Clamp

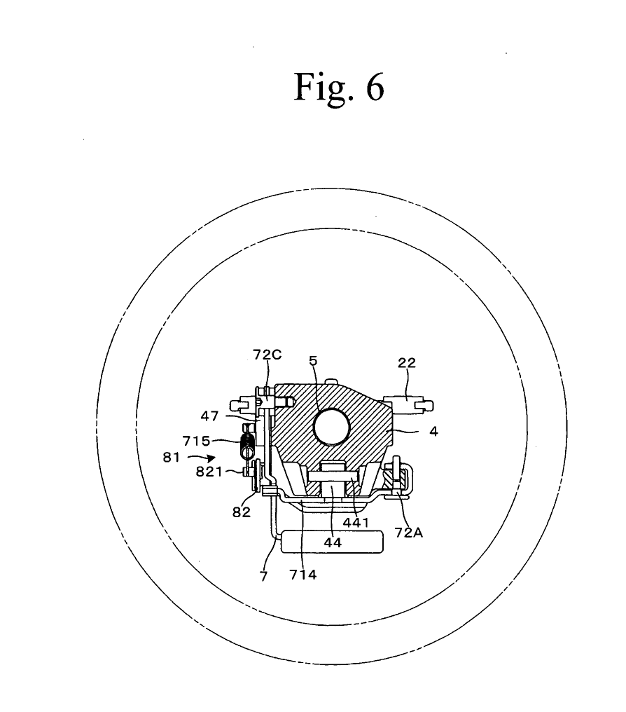

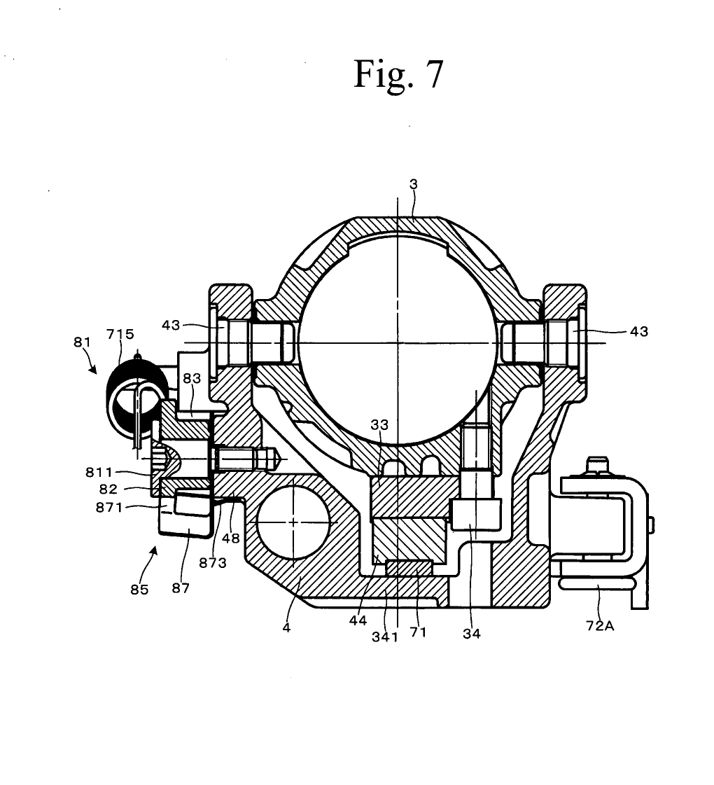

In FIGS. 1, 3, and 4, the control lever 7 in a state before being moved is shown in solid line, and the control lever 7 in a state after being moved toward the steering wheel 92 is shown in two-dot chain line. FIGS. 6 and 7 show cross-sectional views of the steering device 1 taken along lines A-A and B-B in FIG. 1, respectively.

The tilt head clamp 41 is configured as follows. A segment gear 33 having a center at the tilt center shaft 43 is fixed by a bolt 34 to the movable column member 3. The tilt head 4 is provided with a backing member 341 which, being positioned between the tilt head 4 and the segment gear 33, is spaced apart from the segment gear 33.

In the space between the tilt head 4 and the segment gear 33, a gear portion 442 formed in a left portion of a gear arm 44 supported by the tilt head 4 to be rotatable about a shaft 441 and a projection 71 are disposed. The tilt head 4 is attached with a driven lever center shaft 72A (FIGS. 3, 5, 6, and 7). A driven lever 714 (FIGS. 3, 5, and 6) which swings about the driven lever center shaft 72A is formed integrally with the projection 71.

The gear arm 44 is L-shaped having two leg-like portions. The gear portion 442 is formed on one of the two leg-like portions. A spring 711 is interposed between the other leg-like portion 443 and the back of the projection 71. The spring 711 applies a biasing force to the other leg-like portion 443 and the projection 71 in the direction for widening the distance between them.

Referring to FIGS. 3 and 4, when the projection 71 is pushed to the left, it pushes the gear portion 442 from behind causing the gear portion 442 to be pressed against the segment gear 33. As a result, the gear portion 442 and the segment gear 33 engage each other. The reaction force that is applied to the projection 71 when the gear portion 442 is pressed against the segment gear 33 is received by the backing member 341. The tilt head 4 is thus fixed to the movable column member 3. The tilt head 4 is fixed in a stepwise position within a tilt angle range where the tilt head 4 and the gear portion 442 can engage each other.

When the projection 71 moves to the right as seen in FIGS. 3 and 4, the pushing force of the spring 711 causes the gear arm 44 to rotate counterclockwise as seen in FIG. 4. As a result, the gear portion 442 and the segment gear 33 disengage from each other causing the tilt head clamp 41 to be released. Therefore, when tilting of the tilt head is adjusted (the telescopic position is also adjustable at the same time), the projection 71 can be moved to the right by moving the control lever 7.

### Fixed Column Member and Movable Column Member

As shown in FIG. 2, an axially elongated opening 32 is formed through the cylindrical wall of the movable column member 3. A stopper 23 with which the fixed column member 2 is provided is engaged in the elongated opening 32. The stopper 23 engaged in the elongated opening 32 prevents the movable column member 3 from coming off the fixed column member 2 and also from rotating relative to the fixed column member 2. Thus, the movable column member 3 is axially movable in a range defined by the stopper 23 and the elongated opening 32.

### Column Clamp

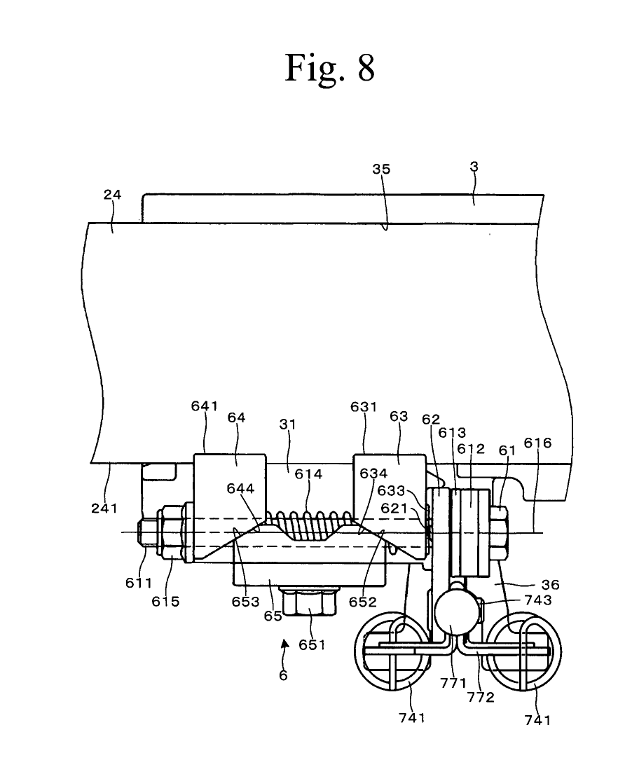

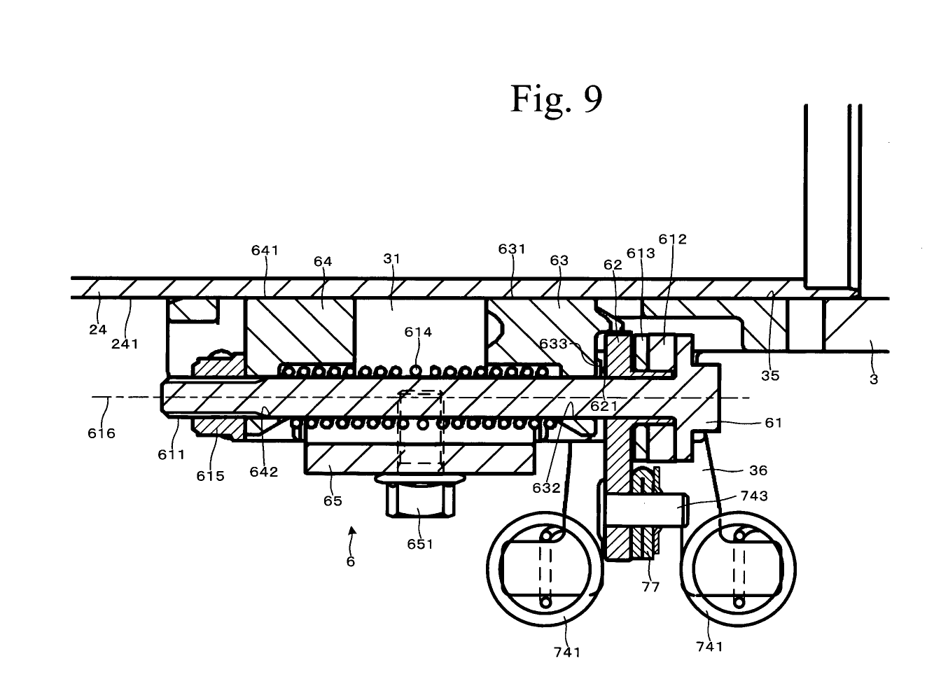

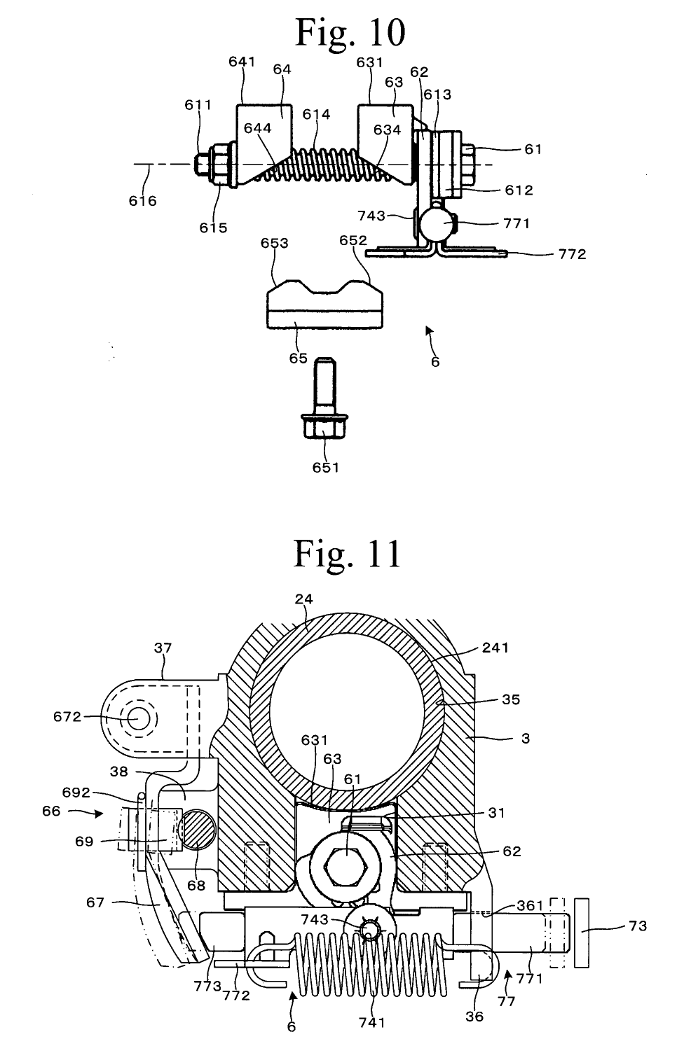

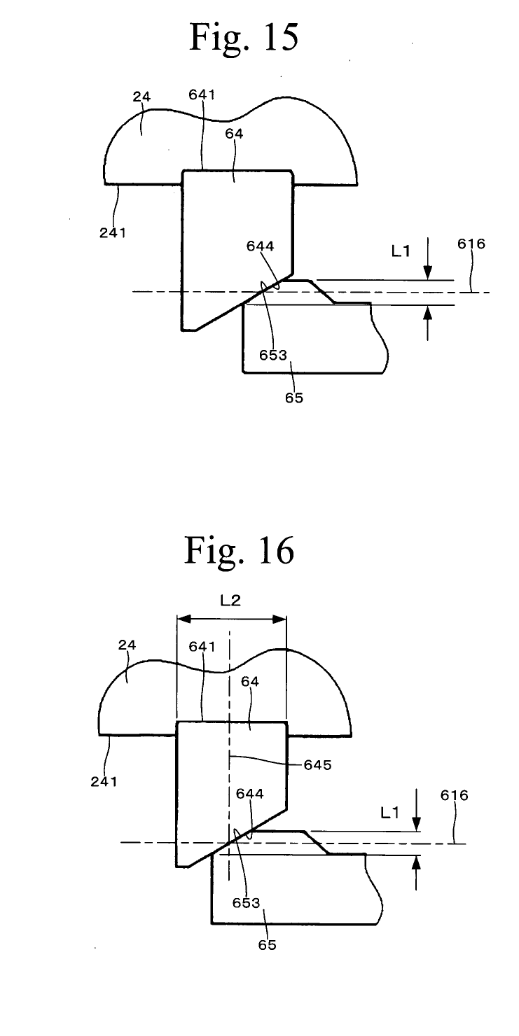

With reference to FIGS. 8 to 11, and 15, the configuration of the column clamp 6 will be described. FIG. 8 is a side view showing an essential part of the column clamp 6. FIG. 9 is a cross-sectional view taken along line C—C in FIG. 5 showing the column clamp 6. FIG. 10 is an exploded view of the column clamp 6 in a sub-assembled state. FIG. 11 is a cross-sectional view taken along line D-D in FIG. 1. FIG. 15 is an enlarged view of a contact area where a slope 644 of a second wedge 64 and a slope 653 of a third wedge 65, which are shown in FIG. 8, are in contact with each other.

The column clamp 6 is provided at the movable column member 3. It includes, from right to left as seen in FIG. 8, a column clamp shaft 61, a thrust bearing 612, a washer 613, a swing arm 62, a first wedge (a first movable wedge) 63, a biasing spring 614, the second wedge (the second movable wedge) 64, and a nut 615.

A wedge hole 31 is formed through an underside of the movable column member 3, as seen in FIG. 8. The wedge hole 31 faces, at its upper end, an outer circumference 241 of a cylindrical guide 24 formed in a portion toward the vehicle rear of the fixed column member 2. The outer circumference 241 of the cylindrical guide 24 is fitted in a guide bore 35 of the movable column member 3 to axially guide the movable column member 3.

The wedge hole 31 is blocked up, at its lower end, by the third wedge (fixed wedge) 65 fixed to the movable column member 3 by two bolts 651. The first and second wedges 63 and 64 are disposed in the wedge hole 31 to be slidable up and down and side to side as seen in FIGS. 8 and 9.

The top faces of the first and second wedges 63 and 64 are approximately arc-shaped to serve as clamp faces 631 and 641, respectively, facing the outer circumference 241 of the cylindrical guide 24. When clamping the movable column member 3, the clamp faces 631 and 641 facing the outer circumference 241 of the cylindrical guide 24 are brought into contact with the outer circumference 241 of the cylindrical guide 24 to clamp the movable column member 3 to the fixed column member 2.

The first and second wedges 63 and 64 are disposed apart from each other in the axial direction of the movable column member 3. The first and second wedges 63 and 64 have clamp shaft holes 632 and 642, respectively, through which the column clamp shaft 61 is inserted. A nut 615 is screwed onto a male thread 611 formed at a left end portion of the column clamp shaft 61. The nut 615 presses against the second wedge 64.

The biasing spring 614 is fitted over the column clamp shaft 61 between the first and second wedges 63 and 64 and constantly pushes the first and second wedges 63 and 64 thereby biasing them to be away from each other. A cam face 633 is formed around the clamp shaft hole 632 on the right end face of the first wedge 63. The cam face 633 is kept in contact with a cam face 621 formed on the left end face of the swing arm 62, the two cam faces thus make up a cam mechanism. To reduce the frictional resistance between the cam faces 633 and 621, rolling contact members such as rollers may be interposed between them.

The third wedge 65 has slopes 652 and 653 outwardly descending with respect to the vertical direction as seen in FIG. 8. The slopes 652 and 653 are in contact with slopes 634 and 644 formed at lower ends of the first and second wedges 63 and 64, respectively.

As shown in FIG. 10, with the third wedge 65 being discrete from the movable column member 3, it is possible to put the column clamp shaft 61, the thrust bearing 612, the washer 613, the swing arm 62, the first wedge 63, the biasing spring 614, the second wedge 64, and the nut 615 together in advance as a subassembly of the column clamp 6 in a subassembly line.

Inserting the subassembly in the wedge hole 31 formed through the underside of the movable column member 3 and clamping the third wedge 65 to the movable column member 3 using the two bolts 651 completes assembly and installation of the column clamp 6. This reduces the time needed to assemble and install the column clamp 6 in a main assembly line, while allowing the subassembly to be prepared with ease in a spacious location.

When the swing arm 62 is swung (clockwise as seen in FIG. 11) to unclamp the movable column member 3 shown in a clamped state in FIGS. 8, and 9, the cam face 621 of the swing arm 62 moves to position its elevated portion against a depressed portion of the cam face 633 of the first wedge 63.

This causes the first and second wedges 63 and 64 to be pushed more away from each other by the biasing spring 614. As a result, the first and second wedges 63 and 64 come down causing the clamp faces 631 and 641 to come off the outer circumference 241 of the cylindrical guide 24, that is, causing the movable column member 3 to be unclamped. Thus, the movable column member 3 can be forcedly unclamped without fail using the pushing force of the biasing spring 614.

When the swing arm 62 is swung in the opposite direction (counterclockwise as seen in FIG. 11), the cam face 621 moves to position its elevated portion against an elevated portion of the cam face 633 of the first wedge 63. This causes the column clamp shaft 61 to be pulled rightward, as seen in FIGS. 8 and 9, causing the second wedge 64 to be pushed also rightward by the nut 615. As a result, the first wedge 63 is pushed leftward by the swing arm 62 to bring the two wedges closer to each other.

As shown in FIG. 15, the center axis 616 of the column clamp shaft 61 is disposed at a middle position of a length L1 of contact between the slope 644 of the second wedge 64 and the slope 653 of the third wedge 65 (contact length in a direction perpendicular to the center axis of the fixed column member 2).

Thus, the pushing force applied to the second wedge 64 when the movable column member 3 is clamped acts on the middle position of the length L of contact between the slope 644 of the second wedge 64 and the slope 653 of the third wedge 65, so that no rotational moment acts on the second wedge 64. This allows the second wedge 64 to smoothly slide over the slope 653 of the third wedge 65.

Though not enlargedly shown, the center axis 616 of the column clamp shaft 61 extends also through a middle position of a length of contact between the slope 634 of the first wedge 63 and the slope 652 of the third wedge 65. Hence, no rotational moment acts on the first wedge 63, either. This allows the first wedge 63 to smoothly slide over the slope 652 of the third wedge 65.

Thus, without any rotational moment to cause the first and second wedges 63 and 64 to tilt generated, the first and second wedges 63 and 64 are allowed to smoothly slide over the slopes 652 and 653 of the third wedge 65, respectively. This causes the clamp faces 631 and 641 of the first and second wedges 63 and 64 to push the outer circumference 241 of the cylindrical guide 24. As a result, the movable column member 3 is securely clamped to the fixed column member 2.

### Second Embodiment

A second embodiment of the present invention will be described next. FIG. 16 is an enlarged view of a contact area where a slope 644 of a second wedge 64 used in the second embodiment and a slope 653 of a third wedge 65 used in the second embodiment are in contact with each other. The following description of the second embodiment will cover only parts and operations differing from those of the first embodiment to avoid duplicate description. The same parts as those used in the first embodiment will be denoted by the same reference numerals as used in the first embodiment.

In the second embodiment, as in the first embodiment, the center axis 616 of the column clamp shaft 61 is disposed at a middle position of a length L1 of contact between the slope 644 of the second wedge 64 and the slope 653 of the third wedge 65 to be parallel with the center axis of the fixed column member 2 or movable column member 3. A middle line 645 passing through a middle position of a length L2 in a direction parallel with the center axis of the movable column member 3 (or fixed column member 2) of the second wedge 64 (the middle line 645 is a normal line passing through a center of the clamp face 641) passes through the middle position of the length L1 of contact between the slope 644 of the second wedge 64 and the slope 653 of the third wedge 65. The second wedge 64 slightly moves in the direction parallel with the center axis of the fixed column member 2 between when clamping and when unclamping the movable column member 3. Inside the range of the movement of the second wedge 64, the middle line 645 of the length L2 of the second wedge 64 is required to pass through an approximately middle position of the length L1 of contact between the slopes 644 and 653 of the second and third wedges 64 and 65.

Though not shown, the center axis 616 of the column clamp shaft 61 extends also through a middle position of a length of contact between the slope 634 of the first wedge 63 and the slope 652 of the third wedge 65. Moreover, a middle line passing through a middle position of a length in the direction parallel with the center axis of the movable column member 3 (or fixed column member 2) of the first wedge 63 passes through the middle position of the length of contact between the slope 634 of the first wedge 63 and the slope 652 of the third wedge 65.

Therefore, the pushing forces applied to the first and second wedges 63 and 64, respectively, when the movable column member 3 is clamped act on the gravity centers of the first and third wedges 63 and 64, respectively. This allows the first and second wedges 63 and 64 to slide over the slopes 652 and 653 of the third wedge 65, respectively, more smoothly than in the first embodiment.

### Other Examples of Wedge Arrangements

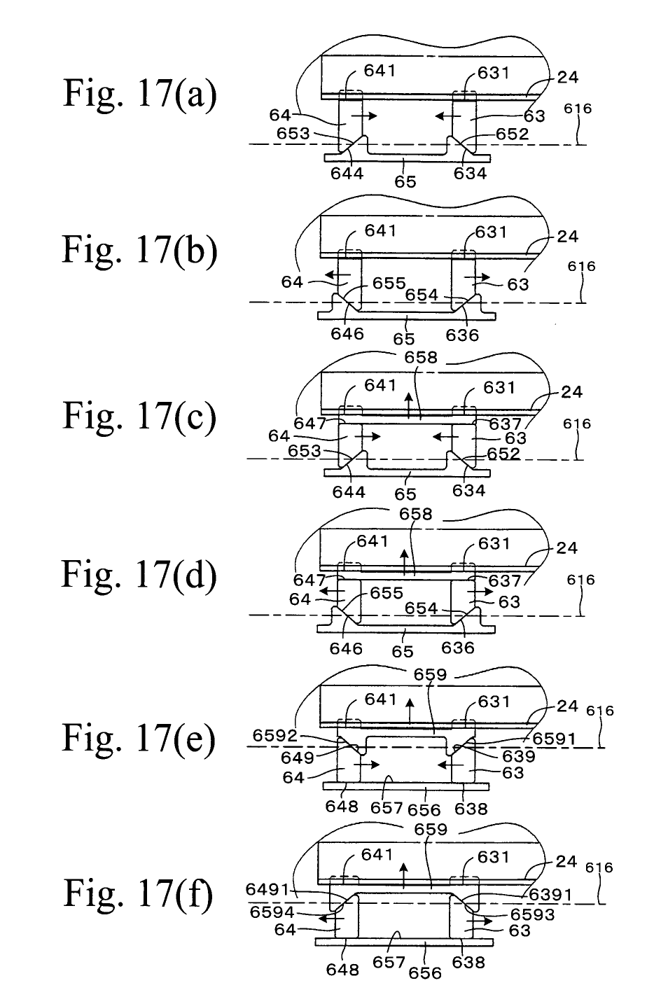

FIGS. 17 (a) to 17 (f) are conceptual diagrams showing other examples of wedge arrangements.

FIG. 17 (a) shows an arrangement of the wedges shown in FIGS. 8 to 11, and 15. The third wedge 65 has the slopes 652 and 653 outwardly descending with respect to the vertical direction as seen in FIG. 17 (a). The slopes 652 and 653 are in contact with the slopes 634 and 644 formed to face each other at lower ends of the first and second wedges 63 and 64, respectively.

When the first and second wedges 63 and 64 move closer to each other as indicated by arrows in FIG. 17 (a), the two wedges are pushed upward. As a result, the clamp faces 631 and 641 of the first and second wedges 63 and 64 are pressed against the outer circumference 241 of the cylindrical guide 24 causing the movable column member 3 to be clamped to the fixed column member 2 at two locations which are spaced apart in the axial direction of the movable column member 3.

The center axis 616 of the column clamp shaft 61 passes through a middle position of the length of contact between the slope 634 of the first wedge 63 and the slope 652 of the third wedge 65 and a middle position of the length of contact between the slope 644 of the second wedge 64 and the slope 653 of the third wedge 65.

Thus, the pushing forces applied to the first and second wedges 63 and 64, respectively, when the movable column member 3 is clamped act on the middle position of the length of contact between the slope 634 of the first wedge 63 and the slope 652 of the third wedge 65 and the middle position of the length of contact between the slope 644 of the second wedge 64 and the slope 653 of the third wedge 65, respectively, so that no rotational moment acts either on the first wedge 63 or on the second wedge 64. This allows the first and second wedges 63 and 64 to smoothly slide over the slopes 652 and 653 of the third wedge 65, respectively.

In the arrangement shown in FIG. 17 (b), the third wedge 65 has slopes 654 and 655 inwardly descending with respect to the vertical direction as seen in FIG. 17 (b). The slopes 654 and 655 are in contact with slopes 636 and 646 formed to face away from each other at lower ends of the first and second wedges 63 and 64, respectively.

When the first and second wedges 63 and 64 move away from each other as indicated by arrows in FIG. 17 (b), the two wedges are pushed upward. As a result, the clamp faces 631 and 641 of the first and second wedges 63 and 64 are pressed against the outer circumference 241 of the cylindrical guide 24 causing the movable column member 3 to be clamped to the fixed column member 2 at two locations which are spaced apart in the axial direction of the movable column member 3.

The center axis 616 of the column clamp shaft 61 passes through a middle position of the length of contact between the slope 636 of the first wedge 63 and the slope 654 of the third wedge 65 and a middle position of the length of contact between the slope 646 of the second wedge 64 and the slope 655 of the third wedge 65.

Thus, the pushing forces applied to the first and second wedges 63 and 64, respectively, when the movable column member 3 is clamped act on the middle position of the length of contact between the slope 636 of the first wedge 63 and the slope 654 of the third wedge 65 and the middle position of the length of contact between the slope 646 of the second wedge 64 and the slope 655 of the third wedge 65, respectively, so that no rotational moment acts either on the first wedge 63 or on the second wedge 64. This allows the first and second wedges 63 and 64 to smoothly slide over the slopes 654 and 655 of the third wedge 65, respectively.

Slopes 652, 653, 634, and 644 of the third wedge 65, first wedge 63, and second wedge 64 shown in FIG. 17 (c) are shaped the same as those shown in FIG. 17 (a). They differ from those shown in FIG. 17 (a) in that the first and second wedges 63 and 64 have flat faces 637 and 647 formed at their upper ends, respectively, with the flat faces 637 and 647 being in contact with an underside of a pressing plate 658 having a length approximately equal to the distance along the center axis of the movable column member 3 between the first and second wedges 63 and 64.

The pressing plate 658 has approximately V-shaped clamp faces 631 and 641 which are formed on a top surface thereof to clamp the outer circumference 241 of the cylindrical guide 24. When the first and second wedges 63 and 64 move closer to each other as indicated by horizontal arrows in FIG. 17 (c), the two wedges are pushed upward thereby pushing up the pressing plate 658 as indicated by a vertical arrow in FIG. 17 (c). As a result, the clamp faces 631 and 641 at the top of the pressing plate 658 are pressed against the outer circumference 241 of the cylindrical guide 24 causing the movable column member 3 to be clamped to the fixed column member 2 at two locations which are spaced apart in the axial direction of the movable column member 3.

Clamping the movable column member 3 via the pressing plate 658 whose thickness is small prevents the clamp surfaces 631 and 641 formed on the pressing plate 658 from biting into the movable column member 3, so that the movable column member 3 can be stably clamped and unclamped.

The center axis 616 of the column clamp shaft 61 passes through a middle position of the length of contact between the slope 634 of the first wedge 63 and the slope 652 of the third wedge 65 and a middle position of the length of contact between the slope 644 of the second wedge 64 and the slope 653 of the third wedge 65.

Thus, the pushing forces applied to the first and second wedges 63 and 64, respectively, when the movable column member 3 is clamped act on the middle position of the length of contact between the slope 634 of the first wedge 63 and the slope 652 of the third wedge 65 and the middle position of the length of contact between the slope 644 of the second wedge 64 and the slope 653 of the third wedge 65, respectively, so that no rotational moment acts either on the first wedge 63 or on the second wedge 64. This allows the first and second wedges 63 and 64 to smoothly slide over the slopes 652 and 653 of the third wedge 65, respectively.

Slopes 654, 655, 636, and 646 of the third wedge 65, first wedge 63, and second wedge 64 shown in FIG. 17 (d) are shaped the same as those shown in FIG. 17 (b). They differ from those shown in FIG. 17 (b) in that the first and second wedges 63 and 64 have flat faces 637 and 647 formed at their upper ends, respectively, with the flat faces 637 and 647 being in contact with an underside of a pressing plate 658 having a length approximately equal to the distance along the center axis of the movable column member 3 between the first and second wedges 63 and 64.

The pressing plate 658 has approximately V-shaped clamp faces 631 and 641 which are formed on a top surface thereof to clamp the outer circumference 241 of the cylindrical guide 24. When the first and second wedges 63 and 64 move away from each other as indicated by horizontal arrows in FIG. 17 (d), the two wedges are pushed upward thereby pushing up the pressing plate 658 as indicated by a vertical arrow in FIG. 17 (d). As a result, the clamp faces 631 and 641 at the top of the pressing plate 658 are pressed against the outer circumference 241 of the cylindrical guide 24 causing the movable column member 3 to be clamped to the fixed column member 2 at two locations which are spaced apart in the axial direction of the movable column member 3.

The center axis 616 of the column clamp shaft 61 passes through a middle position of the length of contact between the slope 636 of the first wedge 63 and the slope 654 of the third wedge 65 and a middle position of the length of contact between the slope 646 of the second wedge 64 and the slope 655 of the third wedge 65.

Thus, the pushing forces applied to the first and second wedges 63 and 64, respectively, when the movable column member 3 is clamped act on the middle position of the length of contact between the slope 636 of the first wedge 63 and the slope 654 of the third wedge 65 and the middle position of the length of contact between the slope 646 of the second wedge 64 and the slope 655 of the third wedge 65, respectively, so that no rotational moment acts either on the first wedge 63 or on the second wedge 64. This allows the first and second wedges 63 and 64 to smoothly slide over the slopes 654 and 655 of the third wedge 65, respectively.

In the arrangement shown in FIG. 17 (e), approximately V-shaped clamp faces 631 and 641 formed on a top surface of a pressing plate 659 clamp the outer circumference 241 of the cylindrical guide 24 as in the arrangements shown in FIGS. 17 (c) and 17 (d). In the arrangement shown in FIG. 17 (e), there is no slope between a cover 656 and the first and second wedges 63 and 64. The top surface of the cover 656 is formed as a flat surface 657. The first and second wedges 63 and 64 have flat surfaces 638 and 648 formed at their bottoms, respectively.

The pressing plate 659 has slopes 6591 and 6592 formed on an underside thereof and outwardly ascending with respect to the vertical direction as seen in FIG. 17 (e). The slopes 6591 and 6592 are kept in contact with mutually facing slopes 639 and 649 formed at upper ends of the first and second wedges 63 and 64, respectively.

When the first and second wedges 63 and 64 move closer to each other as indicated by horizontal arrows in FIG. 17 (e), wedging actions occurring between the slopes 639 and 6591 and between the slopes 649 and 6592 cause the first and second wedges 63 and 64 to push the pressing plate 659 up as indicated by a vertical arrow in FIG. 17 (e). As a result, the clamp faces 631 and 641 at the top of the pressing plate 659 are pressed against the outer circumference 241 of the cylindrical guide 24 causing the movable column member 3 to be clamped to the fixed column member 2 at two locations which are spaced apart in the axial direction of the movable column member 3.

The center axis 616 of the column clamp shaft 61 passes through a middle position of the length of contact between the slope 639 of the first wedge 63 and the slope 6591 of the pressing plate 659 and a middle position of the length of contact between the slope 649 of the second wedge 64 and the slope 6592 of the pressing plate 659.

Thus, the pushing forces applied to the first and second wedges 63 and 64, respectively, when the movable column member 3 is clamped act on the middle position of the length of contact between the slope 639 of the first wedge 63 and the slope 6591 of the pressing plate 659 and the middle position of the length of contact between the slope 649 of the second wedge 64 and the slope 6592 of the pressing plate 659, respectively, so that no rotational moment acts either on the first wedge 63 or on the second wedge 64. This allows the first and second wedges 63 and 64 to smoothly slide over the slopes 6591 and 6592 of the pressing plate 659, respectively.

The arrangements shown in FIGS. 17 (e) and 17 (f) differ in directions of the slopes. In the arrangement shown in FIG. 17 (f), a pressing plate 659 has slopes 6593 and 6594 formed on an underside thereof and descending outwardly with respect to the vertical direction as seen in FIG. 17 (f). The slopes 6593 and 6594 are kept in contact with slopes 6391 and 6491 formed, to face away from each other, at upper ends of the first and second wedges 63 and 64, respectively.

When the first and second wedges 63 and 64 move away from each other as indicated by horizontal arrows in FIG. 17 (f), wedging actions occurring between the slopes 6391 and 6593 and between the slopes 6491 and 6594 cause the first and second wedges 63 and 64 to push the pressing plate 659 up as indicated by a vertical arrow in FIG. 17 (f). As a result, the clamp faces 631 and 641 at the top of the pressing plate 659 are pressed against the outer circumference 241 of the cylindrical guide 24 causing the movable column member 3 to be clamped to the fixed column member 2 at two locations which are spaced apart in the axial direction of the movable column member 3.

The center axis 616 of the column clamp shaft 61 passes through a middle position of the length of contact between the slope 6391 of the first wedge 63 and the slope 6593 of the pressing plate 659 and a middle position of the length of contact between the slope 6491 of the second wedge 64 and the slope 6594 of the pressing plate 659.

Thus, the pushing forces applied to the first and second wedges 63 and 64, respectively, when the movable column member 3 is clamped act on the middle position of the length of contact between the slope 6391 of the first wedge 63 and the slope 6593 of the pressing plate 659 and the middle position of the length of contact between the slope 6491 of the second wedge 64 and the slope 6594 of the pressing plate 659, respectively, so that no rotational moment acts either on the first wedge 63 or on the second wedge 64. This allows the first and second wedges 63 and 64 to smoothly slide over the slopes 6593 and 6594 of the pressing plate 659, respectively.

### Control Lever Operation

In the following, operation of the control lever 7 and parts interlocked with the control lever 7 will be described. As shown in FIGS. 2 to 7, the control lever 7 is swingably attached to the left side of the tilt head 4. The driven lever 714 that swings being driven by the control lever 7, a pusher plate 73 extending leftward (toward the vehicle front) integrally from the driven lever 714, and the projection 71 formed integrally with the driven lever 714 are seen under the tilt head 4. The driven lever 714 and the pusher plate 73 are, as a whole, laterally-inverted L-shaped.

Also, a bias direction reversing mechanism 81 and a swing lever retention mechanism 85 are seen at a side of the tilt head 4. In FIG. 3, the control lever 7 in a state where it has been moved to adjust the position in the front-rear direction and the tilt angle of the tilt head 4 (with the swingable end of the control lever 7 moved toward the steering wheel 92) is shown in two-dot chain line, and the control lever 7 in a state where it has been moved back away from the steering wheel 92 and restored in its initial position is shown in solid line.

FIG. 1 also shows the control lever 7 in a state where it has been moved (moved into an end position b for unclamping) and in a state where it has been restored (moved back into an end position a for clamping) in two-dot chain line and solid line, respectively.

The control lever 7 is swingably supported by a lever center shaft 72C screwed in a side of the tilt head 4. The bias direction reversing mechanism 81 is mounted on a center shaft 811 (FIG. 7) screwed in a side of the tilt head 4. The bias direction reversing mechanism 81 includes a swing lever 82, an engagement pin 821, a pinion 83, and a segment gear 84.

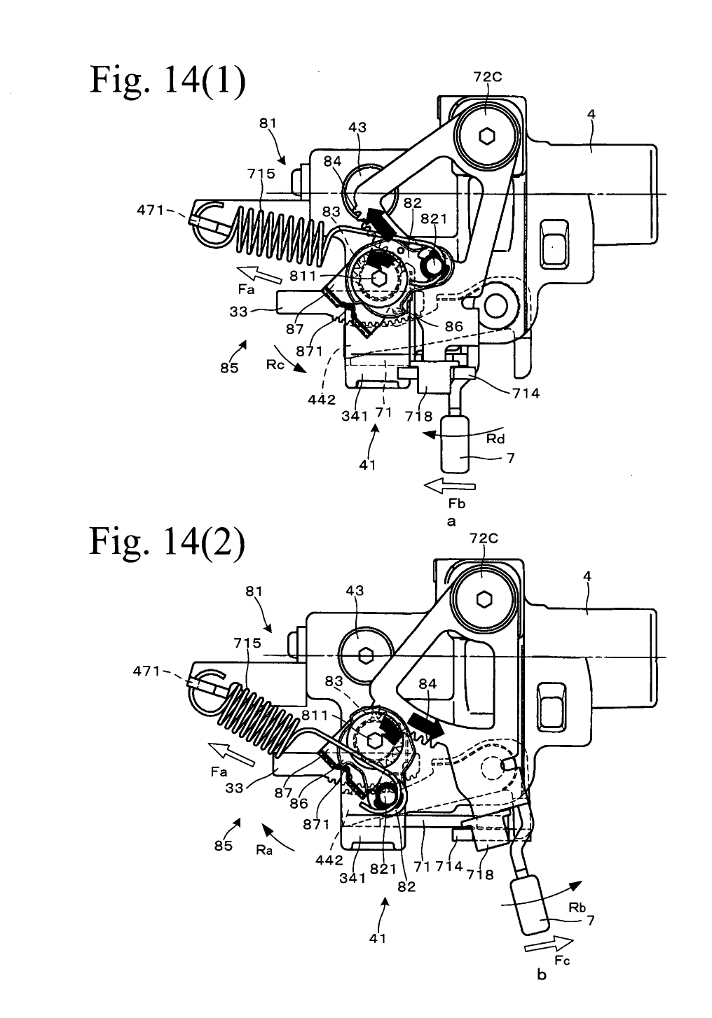

The swing lever 82 is formed of sintered material. It is swingably supported by the center shaft 811 screwed in the side of the tilt head 4. A pinion 83 is formed in a boss portion of the swing lever 82. The pinion 83 engages the segment gear 84 (FIGS. 4, 14 (1), and 14 (2)) formed on the control lever 7.

A biasing spring (biasing member) 715 is stretched between the engagement pin 821 attached to the swing lever 82 and an engagement recess 471 formed on a bracket 47 attached to a left end portion of the tilt head 4. When the control lever 7 is positioned near the end position a for clamping, the biasing spring 715 biases the control lever 7 in the clockwise direction via the swing lever 82, pinion 83, and segment gear 84.

A fork-shaped engagement recess 717 (FIGS. 3 and 5) is formed on the driven lever 714. An engagement projection 718 at an end portion of the control lever 7 is fitted in the engagement recess 717. Therefore, when the control lever 7 is moved, the driven lever 714 is driven to swing about the driven lever center shaft 72A.

Before the control lever 7 is moved, it is positioned as shown in solid line in FIG. 3 (in the end position a for clamping). Namely, the control lever 7 biased by the biasing spring 715 is held in a position for starting a clockwise swing. In this state, the projection 71 of the driven lever 714 is pushed leftward keeping the tilt head 4 clamped.

When the control lever 7 is moved toward the steering wheel 92 to adjust the tilting position and telescopic position of the tilt head 4, the driven lever 714 swings clockwise about the driven lever center shaft 72A. Moving the control lever 7 to the position (the end position b for unclamping) shown in two-dot chain line in FIG. 3 moves the projection 71 integrated with the driven lever 714 rightward thereby releasing the tilt head clamp 41.

When the control lever 7 is moved from the position (the end position a for clamping) shown in solid line in FIG. 3 to the position (the end position b for unclamping) shown in two-dot chain line in FIG. 3, the pressure plate 73 integrated with the driven lever 714 pushes a right head portion 771 at a right end of a pusher rod 77 in to release the column clamp 6. Thus, the tilt head clamp 41 and the column clamp 6 can be released at a time by pulling the control lever 7 once.

The pusher rod 77 (FIGS. 9 and 11) is pivotally supported, at an approximately midpoint of its length in the lateral direction as seen in FIG. 11, by a lower end portion of the swing arm 62 and a pin 743. Referring to FIGS. 5 and 11, the movable column member 3 has a downwardly projecting rib 36 on which a rectangular guide groove 361 is formed. The right head portion 771 at the right end of the pusher rod 77 is fitted in the rectangular groove 361, so that the pusher rod 77 is movable laterally, as seen in FIG. 11, being guided by the guide groove 361.

As shown in FIGS. 5 and 11, two biasing springs 741 are stretched between the rib 36 and a flange 772 of the pusher rod 77, pushing the pusher rod 77 rightward as seen in FIG. 11. The swing arm 62 linked with the pusher rod 77 by the pin 743 is therefore biased for a clockwise rotation. The force biasing the swing arm 62 for a swing keeps the swing arm 62 in a clamping position shown in solid line (FIG. 11).

### Positive Column Clamp

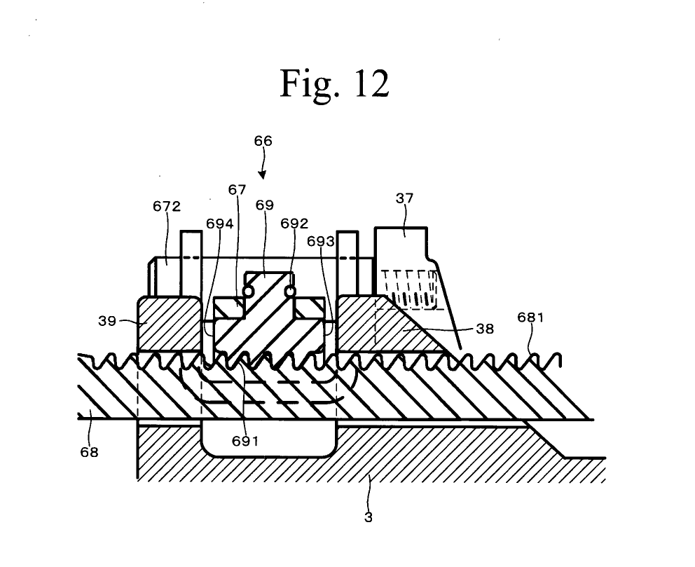

The configuration of a positive column clamp 66 will be described with reference to FIGS. 3 to 5, 11, and 12. FIG. 12 is a cross-sectional view taken along line E—E in FIG. 4. The positive column clamp 66 includes a swing lever 67, a biasing spring 671, a swing center shaft 672, a fixed toothed member 68, and a movable toothed member 69. The positive column clamp 66 is disposed between the movable column member 3 and the fixed column member 2.

The round bar-like fixed toothed member 68 is, with its left end portion inserted in a cylindrical hole 221 (FIG. 4) formed in a side of the body attaching part 22 of the fixed column member 2, fixed to the body attaching part 22 by a pin 222. The fixed toothed member 68 extends long toward the vehicle rear in parallel with the center axis of the fixed column member 2. Plural engagement teeth 681 shaped like saw teeth are formed at a constant pitch approximately over the whole length of the fixed toothed member 68.

The swing center shaft 672 shaped like a round bar is fixedly screwed in a boss 37 projectingly formed on a side of the movable column member 3. The swing center shaft 672 extends toward the vehicle front in parallel with the fixed toothed member 68. The swing lever 67 is supported by the swing center shaft 672 to be swingable about and slidable along the swing center shaft 672.

The movable toothed member 69 is fixed to the swing lever 67 by a clip 692. The movable toothed member 69 has plural engagement teeth 691 shaped like saw teeth and facing the engagement teeth 681 of the fixed toothed member 68. The engagement teeth 691 are formed with the same pitch as the engagement teeth 681.

A biasing spring 671 is stretched between the flange 772 of the pusher rod 77 and the swing lever 67. The swing lever 67 is biased by the biasing spring 671 toward a left head portion 773 at the left end of the pusher rod 77 (in the counterclockwise direction as seen in FIG. 11), and the engagement teeth 691 of the movable toothed member 69 are engaged with the engagement teeth 681 of the fixed toothed member 68.

As shown in FIG. 12, there is some clearance between a rib 38 on a side of the movable column member 3 and an end 693 toward the vehicle rear of the movable toothed member 69 and also between a rib 39 on the side of the movable column member 3 and an end 694 toward the vehicle front of the movable toothed member 69. Namely, when the engagement teeth 691 and 681 engage each other, the swing lever 67 slides along the swing center shaft 672 and the movable toothed member 69 slightly moves in the axial direction of the fixed toothed member 68. This enables engagement between the movable toothed member 69 and the fixed toothed member 68 regardless of the telescopic position clamped by the column clamp 6 using wedges.

When the driver hits the steering wheel 92 at a time of a secondary collision, the movable column member 3 is subjected to an impact force in the direction toward the vehicle front. When the impact force exceeds the clamping force of the column clamp 6 using wedges, the clamp faces 631 and 641 of the first and second wedges 63 and 64, respectively, slide along the outer circumference 241 of the cylindrical guide 24, causing the movable column member 3 to slightly move toward the vehicle front.

With the engagement teeth 691 of the movable toothed member 69 engaging the engagement teeth 681 of the fixed toothed member 68, however, the reaction force applied from the fixed toothed member 68 to the movable toothed member 69 slightly moves the movable toothed member 69 toward the vehicle rear (to the right as seen in FIG. 12) (that is, as seen from the vehicle body side, the movable column member 3 moves to the left as seen in FIG. 12 relative to the movable toothed member 69). When the end 693 toward the vehicle rear of the movable toothed member 69 comes into contact with the rib 38 on a side of the movable column member 3, the movable toothed member 69 can no longer move toward the vehicle rear (that is, as seen from the vehicle body side, the movable column member 3 can no longer move to the left as seen in FIG. 12 relative to the movable toothed member 69), so that the movable column member 3 is prevented from moving toward the vehicle front.

Referring to FIG. 3, when the control lever 7 is moved from the position shown in solid line (the end position a for clamping) to the position shown in two-dot chain line (the end position b for unclamping) to release the tilt head clamp 41 and the column clamp 6, the pusher plate 73 integrated with the driven lever 714 pushes the right head portion 771 at the right end of the pusher rod 77 in, causing the left head portion 773 at the left end of the pusher rod 77 to swing the swing lever 67 (clockwise as seen in FIG. 11).

As a result, the engagement teeth 691 of the movable toothed member 69 and the engagement teeth 681 of the fixed toothed member 68 disengage from each other. This allows the driver to release the control lever 7 and adjust, holding the steering wheel 92 with both hands, the position in the front-rear direction and the tilt angle of the steering wheel 92 (the operation of the swing lever retention mechanism 85 will be described later).

When the driver finishes adjusting the position in the front-rear direction and the tilt angle of the steering wheel 92, the driver releases the steering wheel 92 and moves the control lever 7 back with the released hand, causing the driven lever 714 to swing counterclockwise about the driven lever center shaft 72A. As a result, the tilt head 4 is clamped to the movable column member 3. At the same time, the pusher plate 73 swings to the position shown in solid line in FIG. 3, causing the pusher rod 77 biased by the biasing springs 741 to move rightward, as seen in FIG. 11, to the position shown in solid line.

The rightward move of the pusher rod 77 causes the swing arm 62 to swing counterclockwise and the first and second wedges 63 and 64 of the column clamp 6 to come closer to each other. As a result, the movable column member 3 is clamped.

When the pusher rod 77 moves to the right, the biasing force of the biasing spring 671 causes the swing lever 67 to start swinging counterclockwise, and the engagement teeth 691 of the movable toothed member 69 attached to the swing lever 67 start engaging the engagement teeth 681 of the fixed toothed member 68.

Since the column clamp 6 makes clamping by friction using wedges, the clamped position of the movable column member 3 can be adjusted steplessly. The positive column clamp 66 that includes the movable toothed member 69 and the fixed toothed member 68 makes clamping in steps defined by the pitch of the engagement teeth 681 and 691. This may cause the engagement between the engagement teeth 691 of the movable toothed member 69 and the engagement teeth 681 of the fixed toothed member 68 to be displaced.

The swing lever 67 to which the movable toothed member 69 is attached, however, slides, being guided by the swing center shaft 672, a distance equal to the engagement displacement along the center axis of the fixed toothed member 68. The engagement teeth 691 of the movable toothed member 69 are thus enabled to correctly engage the engagement teeth 681 of the fixed toothed member 68.

### Bias Direction Reversing Mechanism

The configuration and operation of the bias direction reversing mechanism 81 will be described below with reference to FIGS. 14 (1) and 14 (2). FIG. 14 (1) is an operation diagram showing the bias direction reversing mechanism 81 with the control lever 7 in the end position a for clamping shown in solid line in FIGS. 1 and 3 (the state before the control lever 7 is moved). FIG. 14 (2) is an operation diagram showing the bias direction reversing mechanism 81 with the control lever 7 in the end position b for unclamping shown in two-dot line in FIGS. 1 and 3 (the state after the control lever 7 is moved).

Referring to FIG. 14 (1), when the control lever 7 is in the end position a for clamping, the swing lever 82 is biased toward a swing end in the counterclockwise direction about the center shaft 811 (the direction of the filled arrow Rc) by a biasing force Fa of the biasing spring 715 via the engagement pin 821. In this state, the segment gear 84 engaging the pinion 83 is biased in the clockwise direction, so that the control lever 7 is biased toward a swing end in the clockwise direction (the direction of the filled arrow Rd) by a biasing force (denoted by the hollow arrow Fb).

At this time, the projection 71 of the driven lever 714 is pushed to the left, and the tilt head clamp 41 is in a clamping state. The pressure plate 73 integrated with the driven lever 714 is in the position shown in solid line in FIG. 3, so that the column clamp 6 is also in a clamping state.

When the control lever 7 is moved toward the steering wheel 92, the control lever 7 swings, as shown in FIG. 14 (2), counterclockwise (in the direction of the filled arrow Rb) about the lever center shaft 72C. As a result, the segment gear 84 rotates the pinion 83 clockwise (in the direction of the filled arrow Ra), so that the swing lever 82 integrated with the pinion 83 also swings clockwise (in the direction of the filled arrow Ra).

In FIGS. 14 (1) and 14 (2), the filled arrows Ra and Rc respectively denote the swing directions of the swing lever 82, the filled arrows Rb and Rd the swing directions of the control lever 7, the hollow arrows Fa, Fb, and Fc the directions in which the swing lever 82 and the control lever 7 are biased by the biasing spring 715.

When the swing lever 82 swings clockwise (in the direction of the filled arrow Ra), the center of the engagement pin 821 comes closer to a linear line passing through the engagement recess 471 and the center shaft 811. This causes the vertical distance between the center of the center shaft 811 and the vector of the biasing force (denoted by the hollow arrow Fa) of the biasing spring 715 acting on the engagement pin 821 to gradually approach zero. Hence, the moment of force of the biasing spring 715 applied to the engagement pin 821 to swing the swing lever 82 counterclockwise gradually approaches zero.

Therefore, as the centers of the engagement recess 471, center shaft 811, and engagement pin 821 come closer to their respective positions where they are aligned on a straight line, the clockwise biasing force (denoted by the hollow arrow Fb) applied by the biasing spring 715 to the control lever 7 gradually approaches zero. As a result, the force required to move the control lever 7 toward the steering wheel 92 opposing the biasing force of the biasing spring 715 gradually approaches zero. At this time, the driven lever 714 driven by the control lever 7 swings clockwise about the driven lever center shaft 72A. This causes the projection 71 integrated with the driven lever 714 to move to the right and unclamping by the tilt head clamp 41 to progress.

At the same time, the pusher plate 73 integrated with the driven lever 714 pushes the right head portion 771 of the pusher rod 77 in opposing the biasing forces of the biasing springs 741, so that unclamping operations of the column clamp 6 and positive column clamp 66 progress. Therefore, the force required to move the control lever 7 toward the steering wheel 92 gradually increases by addition of the force required to push in the pusher rod 77 opposing the biasing forces of the biasing springs 741.

As the control lever 7 is moved closer to the steering wheel 92, the centers of the engagement recess 471, center shaft 811, and engagement pin 821 are aligned on a straight line, causing the moment of force of the biasing spring 715 for swinging the swing lever 82 counterclockwise to become zero. When the control lever 7 is moved still closer to the steering wheel 92, the swing lever 82 further swings clockwise (in the direction of the filled arrow Ra), causing the engagement pin 821 to come away from the straight line passing through the centers of the engagement recess 471 and center shaft 811.

At this time, as shown in FIG. 14 (2), the swing lever 82 is biased for a clockwise swing about the center shaft 811 by the biasing spring 715 via the engagement pin 821, and the segment gear 84 engaging the pinion 83 is biased counterclockwise, so that the control lever 7 is biased in the counterclockwise direction (denoted by the hollow arrow Fc). Namely, the direction in which the control lever 7 is biased by the biasing spring 715 is reversed when the state where the centers of the engagement recess 471, center shaft 811, and engagement pin 821 are aligned on a straight line is passed.

As the swing lever 82 swings clockwise (in the direction of the filled arrow Ra) and the centers of the engagement recess 471, center shaft 811, and engagement pin 821 come more away from their respective positions aligned on a straight line, the vertical distance between the center of the center shaft 811 and the vector of the biasing force (denoted by the hollow arrow Fa) of the biasing spring 715 acting on the engagement pin 821 gradually increases. Hence, the moment of force of the biasing spring 715 applied to the engagement pin 821 to swing the swing lever 82 clockwise (in the direction of the filled arrow Ra) gradually increases.

Therefore, the counterclockwise biasing force (denoted by the hollow arrow Fc) applied by the biasing spring 715 to the control lever 7 gradually increases. As a result, the force required for the pusher plate 73 to push in the pusher rod 77 opposing the biasing forces of the biasing springs 741 gradually decreases, so that the force required to move the control lever 7 toward the steering wheel 92 gradually decreases.

When the control lever 7 reaches the end position b for unclamping, shown in FIG. 14 (2), the projection 71 integrated with the driven lever 714 reaches a right end position and the tilt head clamp 41 completes unclamping. At the same time, the pressure plate 73 integrated with the driven lever 714 pushes the right head portion 771 of the pusher rod 77 in, and the column clamp 6 and positive column clamp 66 also complete unclamping.

In this state, even when the control lever 7 is released, the control lever 7 is held in the end position b for unclamping, shown in FIG. 14 (2), and the tilt head clamp 41, column clamp 6, and positive column clamp 66 remain in a released state (the operation of the swing lever retention mechanism 85 will be described later). This allows the driver to adjust, holding the steering wheel 92 with both hands, the tilt angle and the position in the front-rear direction of the steering wheel 92 with ease.

When the driver finishes adjusting the tilt angle and the position in the front-rear direction of the steering wheel 92, the driver releases one hand from the steering wheel 92 and moves, with the released hand, the control lever 7 in the direction away from the steering wheel 92. This causes the tilt head clamp 41, column clamp 6, and positive column clamp 66 to carry out clamping in reverse of the above order, thereby restoring the state shown in FIG. 14 (1).

Since the control lever 7 is biased in the clockwise direction by the biasing spring 715, it remains in the end position a for clamping, shown in FIG. 14 (1), even after the driver releases the control lever 7.

### Swing Lever Retention Mechanism

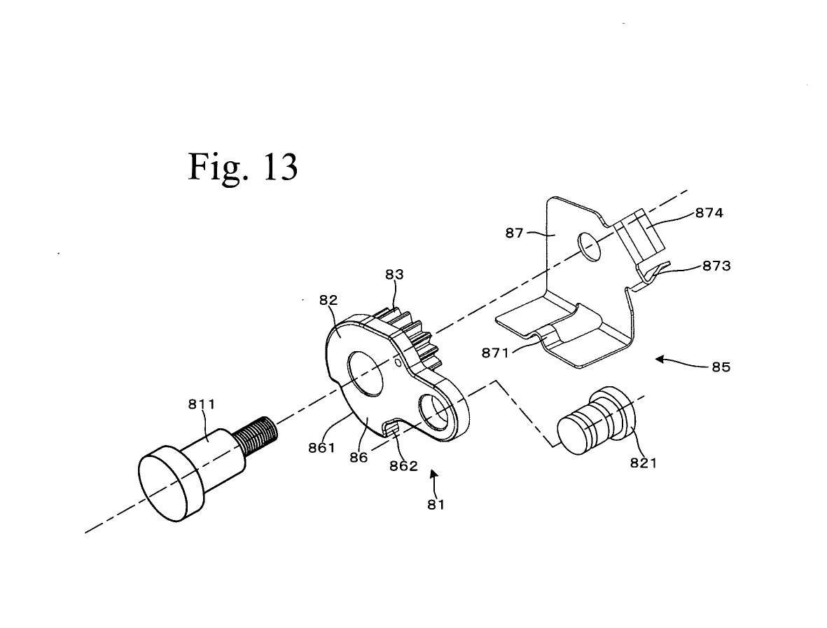

The configuration and operation of the swing lever retention mechanism 85 will be described with reference to FIGS. 7, 13, 14 (1), and 14 (2). FIG. 13 is an exploded perspective view showing the swing lever and a swing lever retention spring. The counterclockwise biasing force (denoted by the hollow arrow Fc) applied to the control lever 7 by the biasing force (denoted by the hollow arrow Fa) of the biasing spring 715 is preferably approximately equivalent to or slightly larger than the force required to push in the pusher rod 77 opposing the biasing forces of the biasing springs 741 for the column clamp 6 and positive column clamp 66.

This is because when the biasing force of the biasing spring 715 is increased, the force required to move the control lever 7 out of the end position b for unclamping into the end position a for clamping correspondingly increases. Furthermore, the force required to move the control lever 7 out of the end position a for clamping into the end position b for unclamping (that is, to move the control lever 7 until the center axis of the biasing spring 715 passes the center shaft 811) also increases.

It is to avoid the above problems that the biasing force of the biasing spring 715 is set to be approximately equivalent to or slightly larger than the force required to push the pusher rod 77 in. In this arrangement, however, the control lever 7 can move easily when it is in the end position b for unclamping, so that, when the position in the front-rear direction or the tilt angle of the steering wheel 92 is adjusted, inertia generated during the adjustment work, i.e. impacts and vibrations, may cause the control lever 7 to be displaced.

To eliminate the problem as described above, the swing lever retention mechanism 85 provided for the tilt head 4 serves to retain the control lever 7 in the end position b for unclamping. As shown in FIGS. 7, 13, 14 (1), and 14 (2), the swing lever retention mechanism 85 includes an engagement projection 86 formed on the outer circumference of the swing lever 82 and a swing lever retention spring 87 having an engagement projection 871.

The swing lever retention spring 87 is attached, together with the swing lever 82, to a side of the tilt head 4 by the center shaft 811 screwed in the tilt head 4. Engagement projections 873 and 874 formed by the swing lever retention spring 87 are in tight contact with the outer circumference of a boss portion 48 on the side of the tilt head 4, so that swinging of the swing lever 82 does not cause the swing lever retention spring 87 to swing. Thus, the swing lever retention spring 87 is fixedly attached to the side of the tilt head 4.

The engagement projection 871 of the swing lever retention spring 87 is formed with a ridge-like top oriented toward the center of the swing lever 82. The engagement projection 86 formed on the outer circumference of the swing lever 82 is shaped like a saw tooth having a gentle slope 861 and a steep slope 862. The gentle slope 861 is shaped approximately like a circular arc whose diameter is larger where it is closer to the steep slope 862. The steep slope 862 stretches from the top of the gentle slope 861 toward the center of the swing lever 82 (a plane stretching approximately toward the center of the swing lever 82). When the swing lever retention mechanism 85 is assembled, the top of the gentle slope 861 is positioned more away, in a radial direction, from the center of the swing lever 82 than the ridge-like top of the engagement projection 871 of the swing lever retention spring 87.

When the control lever 7 is moved out of the end position a for clamping shown in FIG. 14 (1), toward the end position b for unclamping shown in FIG. 14 (2), the swing lever 82 swings clockwise (in the direction denoted by the filled arrow Ra) with the gentle slope 861 of the engagement projection 86 causing the engagement projection 871 of the swing lever retention spring 87 to undergo outward elastic deformation in a radial direction.

When the control lever 7 reaches the end position b for unclamping shown in FIG. 14 (2), the top of the gentle slope 861 passes the ridge-like top of the engagement projection 871 of the swing lever retention spring 87 causing the steep slope 862 and the ridge-like top of the engagement projection 871 to engage each other. In this state, the swing lever 82 is prevented from swinging counterclockwise, so that the control lever 7 is held in the end position b for unclamping. Hence, impacts generated during positional adjustment of the steering wheel 92 cannot cause the control lever 7 to be displaced out of the end position b for unclamping toward the end position a for clamping.

According to the embodiment of the present invention, the gentle slope 861 is formed on the engagement projection 86. When the control lever 7 is moved toward the end position b for unclamping thereby causing the swing lever 82 to swing, the gentle slope 861 causes the engagement projection 871 of the swing lever retention spring 87 to gradually undergo outward elastic deformation in a radial direction. This causes the driver operating the control lever 7 to obtain a good operational feeling.

The swing lever 82 is formed of sintered material, so that it is smooth-surfaced resulting in a small friction factor between its engagement projection 86 and the engagement projection 871 of the swing lever retention spring 87. This allows the driver operating the control lever 7 to obtain a good operational feeling. Moreover, the wear of the swing lever 82 and swing lever retention spring 87 is reduced, and their durability improves.

### Steering Wheel Adjustment

The operations for adjusting the position in the front-rear direction and the tilt angle of the steering wheel 92 and the movements of associated parts will be described below.

When adjusting the position in the front-rear direction and the tilt angle of the steering wheel 92, the driver releases one hand from the steering wheel 92 and moves, with the released hand, the control lever 7 out of the end position a for clamping toward the end position b for unclamping (in the direction denoted by the filled arrow Rb). In this operation, the control lever 7 causes the driven lever 714 to swing clockwise about the driven lever center shaft 72A as shown in FIG. 3.

When the driven lever 714 swings, the projection 71 moves to the right, as seen in FIGS. 3 and 4, and the biasing force of the biasing spring 711 causes the gear arm 44 to rotate counterclockwise. As a result, the segment gear 33 and the gear portion 442 of the gear arm 44 disengage from each other, thereby making the tilt angle of the tilt head 4 adjustable. Also, the pusher plate 73 swings to the position shown in two-dot line in FIG. 3 thereby pushing the pusher rod 77 leftward, as seen in FIG. 3, opposing the biasing forces of the biasing springs 741 to the position shown in two-dot line in FIG. 11.

When the pusher rod 77 moves leftward, the swing arm 62 and the swing lever 67 swing clockwise. As a result, the first and second wedges 63 and 64 positioned close to each other as shown in FIGS. 8 and 9 move away from each other causing the movable column member 3 to be unclamped. Also, the engagement teeth 691 of the movable toothed member 69 and the engagement teeth 681 of the fixed toothed member 68 disengage from each other causing the positive column clamp 66 to be released.

In the bias direction reversing mechanism 81, when the centers of the engagement recess 471, center shaft 811 and engagement pin 821 are aligned on a straight line during unclamping operations of the tilt head clamp 41, column clamp 6 and positive column clamp 66, the direction in which the control lever 7 is biased by the biasing spring 715 changes from clockwise (the direction denoted by the hollow arrow Fb) to counterclockwise (the direction denoted by the filled arrow Fc).

Therefore, the biasing force of the biasing spring 715 is added to the force used to make the pusher plate 73 for the column clamp 6 and positive column clamp 66 push the pusher rod 77 in opposing the biasing forces of the biasing springs 741. This reduces the force the driver is required to use to move the control lever 7 toward the steering wheel 92.

When the control lever 7 reaches the end position b for unclamping as shown in FIG. 14 (2), the engagement projection 871 at an edge of the swing lever retention spring 87 engages the engagement projection 86 of the swing lever 82, so that the control lever 7 is securely held in the end position b for unclamping. This allows the driver to release the control lever 7 and adjust, holding the steering wheel 92 with both hands, the position in the front-rear direction and the tilt angle of the steering wheel 92 with ease.

When the driver finishes adjusting the position in the front-rear direction and the tilt angle of the steering wheel 92, the driver releases one hand from the steering wheel 92 and moves, with the released hand, the control lever 7. As the control lever 7 moves clockwise, the steep slope 862 of the engagement projection 86 formed on the swing lever 82 slides over and beyond the engagement projection 871 of the swing lever retention spring 87 causing the gentle slope 861 of the engagement projection 86 to subsequently slide along the engagement projection 871 of the swing lever retention spring 87.

In the bias direction reversing mechanism 81, when the centers of the engagement recess 471, center shaft 811 and engagement pin 821 are aligned on a straight line during clamping operations of the tilt head clamp 41, column clamp 6 and positive column clamp 66, the direction in which the control lever 7 is biased by the biasing spring 715 changes from counterclockwise (the direction denoted by the filled arrow Fc) to clockwise (the direction denoted by the hollow arrow Fb). As a result, the biasing force of the biasing spring 715 causes the control lever 7 to move clockwise, so that the force required to move the control lever 7 is reduced.

As the control lever 7 moves clockwise, the driven lever 714 biased by the biasing spring 715 swings counterclockwise about the driven lever center shaft 72A, causing the projection 71 to move leftward as seen in FIG. 3 and the segment gear 33 and the gear portion 442 of the gear arm 44 to engage each other. As a result, the tilt head 4 is clamped to the movable column member 3. At the same time, the pusher plate 73 swings to the position shown in solid line in FIGS. 3 and 11, and the biasing forces of the biasing springs 741 cause the pusher rod 77 to return, by moving rightward as seen in FIG. 11, to the position shown in solid line in FIG. 11.

When the pusher rod 77 moves rightward, the swing arm 62 swings counterclockwise. As a result, the first and second wedges 63 and 64 shown in FIGS. 8 and 9 move closer to each other causing the movable column member 3 to be clamped. Also, the swing lever 67 swings counterclockwise causing the engagement teeth 691 of the movable toothed member 69 and the engagement teeth 681 of the fixed toothed member 68 to engage each other. This completes a clamping operation of the positive column clamp 66.

Even after the control lever 7 is released, the biasing force of the biasing spring 715 included in the bias direction reversing mechanism 81 holds the control lever 7 in the end position a for clamping, so that the column clamp 6, positive column clamp 66, and tilt head clamp 41 are kept in a clamping state.

When unclamped by the tilt head clamp 41, the tilt head 4 is subjected, like when a person hangs his or her head down, to a downward force attributable to its weight. A rather strong spring 45 (FIGS. 3 to 5) is provided to counterbalance the downward force. The spring 45 that counterbalances the downward force may also be used to provide the tilt head 4 with a force for holding the steering wheel 92 in a highest inclined position to allow the driver to get on or off the vehicle with ease.

Even though, in the above embodiments, the present invention is applied to a steering device in which the movable column member 3 is provided with the column clamp 6 including the first wedge 63, second wedge 64, third wedge 65, and column clamp shaft 61, the present invention may also be applied to a steering device in which the fixed column member 2 is provided with the column clamp 6.

Even though, in the above embodiments, the present invention is applied to a steering device having a tilt head clamp and a column clamp, the present invention may also be applied to a steering device having a column clamp and no tilt head clamp. Furthermore, in the above embodiments, the present invention is applied to a steering device in which a tilt head clamp and a column clamp can be controlled simultaneously using a single control lever, the present invention may also be applied to a steering device in which a tilt head clamp and a column clamp are separately controlled using separate control levers.

This application is based on application No. 2006-147 filed in Japan, the contents of which are hereby incorporated by reference.

What is claimed is:

1. A steering device, comprising:
a fixed column member having a body attaching part for attaching the steering device to a vehicle body,
a movable column member, one end of the movable column member being supported by the fixed column member nonrotatably about and movably along a center axis of the fixed column member,
a steering shaft which is rotatably supported by the movable column member and to one end of which a steering wheel is fixed,
a movable wedge movably supported by one of the movable column member and the fixed column member, the movable wedge having a clamp face and a slope formed on a side opposite to the clamp face,
a fixed wedge fixed to the one of the movable column member and the fixed column member, the fixed wedge having a slope which engages the slope of the movable wedge, and
a column clamp shaft operable by a vehicle driver to move the movable wedge over the slope of the fixed wedge,
wherein a center axis of the column clamp shaft substantially passes through a middle point of a contact area of the slopes of the movable wedge and the fixed wedge.

2. A steering device according to claim 1,
wherein a normal line passing through a center of the clamp face of the movable wedge substantially passes through the middle point of the contact area.

3. A steering device according to one of claims 1 and 2, further comprising another movable wedge and another fixed wedge, the another movable wedge and the another fixed wedge being spaced apart, in a direction of a center axis of the fixed column member, from the movable wedge and the fixed wedge, respectively,
wherein the two movable wedges move closer to or away from the fixed column member to clamp the movable column member to the fixed column member by moving closer to or away from each other.

4. A steering device according to claim 3,
wherein a spring is provided between the two movable wedges for biasing the movable wedges away from each other.
